(19) United States
(12) Patent Application Publication
(10) Pub. No.: US 2007/0232176 A1
(43) Pub. Date: Oct. 4, 2007

(54) Flame retardant composite fabric

(75) Inventors: Arthur Henry Cashin, Nashville, TN (US); James Neil Nicholson, Greenville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Reemay, Inc.

(21) Appl. No.: 11/231,693

(22) Filed: Sep. 21, 2005

Related U.S. Application Data
(60) Provisional application No. 60/612,584, filed on Sep. 23, 2004.

(51) Int. Cl. B32B 5/26; D04H 3/16; D04H 1/00; D04H 13/00

(52) U.S. Cl. 442/381; 442/401; 442/414; 442/415; 442/416

(57) ABSTRACT

A composite flame retardant fabric is provided comprising an interior layer formed of thermoplastic fibers and exterior nonwoven webs on opposite sides of the interior layer. The exterior webs are formed of cellulosic fibers that include a flame retardant chemical. The interior layer provides strength and integrity to the composite fabric while allowing the composite to remain flexible and light in weight. The exterior layers impart flame retardant properties to the composite. Preferably, the interior layer is a spunbonded nonwoven fabric, and in a preferred embodiment the interior layer is a polyester spunbond nonwoven fabric. The exterior layers are preferably carded nonwoven webs, and in a preferred embodiment, the carded webs comprise rayon fibers that have been treated with a flame retardant chemical.

### CROSS-REFERENCE TO RELATED APPLICATIONS

This application is related to and claims priority from U.S. Provisional Patent Application No. 60/612,584 filed Sep. 23, 2004.

### BACKGROUND OF THE INVENTION

The present invention relates to a flame retardant composite fabric and to articles of manufacture such as mattresses, furniture and the like containing the flame retardant composite fabric.

Considerable attention has been given to the safety hazards presented by the flammability of home furnishings such as furniture, upholstery and bedding, and as a result various governmental regulations have been enacted establishing flame resistant standards for home furnishings. For example, California Assembly Bill 603 (AB603) requires all bed sets manufactured for sale in the state of California to comply with the test standards set forth in Test Bulletin 603 (TB603). Compliance to this standard for all mattress and box springs sets manufactured for sale in California is required by Jan. 1, 2005. Standards are also being developed for top of the bed products such as bed covers, quilts, duvets, etc. In California, test standard TB604 applies to bed covering materials. California test TB 117 & TB 133 is applicable to upholstery; and NFPA 701 for curtains and drapes

It has been recognized that many fires can be contained or minimized if the initial ignition source fails to reach significant fuel to sustain or expand the fire. Therefore, flame barrier fabrics have been proposed that can be placed just below the decorative outer fabric on a mattress, box springs, sofa or the like to prevent the fire from spreading and reaching the flammable interior cushioning material. Examples of such approaches are described for example in the following publications: U.S. Pat. Nos. 5,091,243; 5,540,890; 5,491,022; 4,794,037; 4,748,705; 4,040,371; 3,765,837; and 3,934,285; and in U.S. Patent Application Publication Nos. US 2003/0224679, US 2003/0129901 and US 2003/0082972.

To pass the currently known flame barrier standards, most manufacturers have found it necessary to use relatively high basis weight barrier fabrics, for example in the 6 to 16 oz./yd² range. As a result, the barrier fabrics are fairly stiff or lacking in “hand”, such that they undesirably change the feel of the surface of the finished product. In addition, the previously available barrier fabrics are relatively expensive, and in some designs the flame retardant treatment will wash or abrade off during use or the product will crush over time in use resulting in degradation of the flame barrier performance.

The present invention addresses the above-noted limitations of currently available flame barrier products, and provides a product that is capable of meeting the applicable flame requirements with a much lighter basis weight fabric. Because of the significantly enhanced performance to weight relationship achieved by the composite fabrics of the present invention, the fabrics provide significant improvement in softness or “hand” when incorporated into bedding, bed coverings, draperies, furniture or the like.

### BRIEF SUMMARY OF THE INVENTION

According to the present invention, a composite flame retardant fabric is provided comprising an interior layer formed of thermoplastic fibers and exterior nonwoven webs on opposite sides of the interior layer. The exterior webs are formed of cellulosic fibers that include a flame retardant chemical. The interior layer provides strength and integrity to the composite fabric while allowing the composite to remain flexible and light in weight. The exterior layers impart flame retardant properties to the composite. Preferably, the interior layer is a spunbonded nonwoven fabric, and in a preferred embodiment the interior layer is a polyester spunbond nonwoven fabric. The exterior layers are preferably carded nonwoven webs, and in a preferred embodiment, the carded webs comprise rayon fibers that have been treated with a flame retardant chemical.

In one advantageous embodiment, the outer layers are carded nonwoven webs comprising a blend of rayon fibers and polyester fibers. The blend preferably comprises at least 50% by weight flame retardant-infused rayon fibers. The flame retardant infused rayon fibers may desirably contain from 10 to 40% by weight flame retardant chemical.

The composite fabric of the present invention provides excellent flame retardant properties without adversely affecting the softness or feel of the article of manufacture. The fabric suitably has a basis weight of from 2 to 6 oz./yd² (67-204 gsm) and in some embodiments from 2½ to 4 oz./yd² (85-136 gsm)

The composite flame retardant fabric of the present invention can be used in the manufacture of flame retardant bedding, such as mattresses, box springs or bed covers, by positioning the flame retardant fabric between the outer decorative fabric of the bedding and the inner cushioning material. The composite flame retardant fabric can also be incorporated into furniture, such as upholstered chairs, sofas and the like. The composite flame retardant fabric is positioned between the decorative outer fabric of the furniture and the inner cushioning member.

### BRIEF DESCRIPTION OF THE SEVERAL VIEWS OF THE DRAWING(S)

Some of the features and advantages of the invention having been described, others will become apparent from the detailed description which follows, and from the accompanying drawings, in which:

FIG. 1 is a schematic partial cross-sectional view of a mattress incorporating the barrier fabric of the present invention;

FIG. 2 is an enlarged cross-sectional view illustrating the composite barrier fabric; and

FIG. 3 is a schematic view illustrating a process line for the manufacture of the composite fabric.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As shown in FIG. 1, the composite barrier fabric of the present invention is indicated by the reference character 10. As shown in FIG. 1, the barrier fabric 10 is incorporated into a mattress 11. The mattress shown in FIG. 1 has a core formed by springs 12, and multiple layers of cushioning material 14 are positioned on opposite sides of the core. The cushioning material may comprise cotton batting, foam, or other known materials. These layers of cushioning material are typically flammable, and will burn when exposed to flame. The mattress also includes an outer decorative fabric 16 which covers opposite surfaces and the surrounding sides of the mattress. In accordance with the present invention, the barrier fabric 10 of the present invention is positioned just beneath the outer decorative fabric 16 so that it forms a barrier between the outer fabric and the underlying interior cushioning materials.

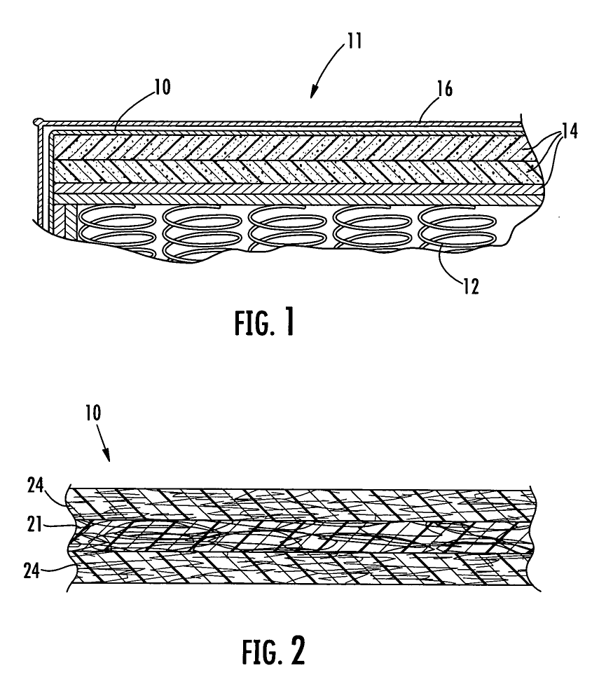

As seen more clearly in FIG. 2, the composite barrier fabric 10 includes an interior layer 21 which, in the illustrated embodiment, is a spunbonded nonwoven fabric. The spunbond nonwovens used in the present invention are made from continuous polymeric filaments that are bonded together. Generally, spunbond nonwoven fabrics are prepared by extruding a thermoplastic polymer through a large number of fine spinneret orifices to form a multiplicity of continuous filaments, and the filaments of molten polymer are solidified and then drawn or attenuated, typically by high velocity air, and then randomly deposited on a collection surface. The filaments are then bonded to give the web coherency and strength. Common bonding methods that may be used include, for example, thermal bonding, chemical bonding with a resin or adhesive, thru-air bonding, sonic bonding, hydroentangling, and the like.

Area bonding and point bonding are two common techniques for thermal bonding the web. Area bonding typically involves passing the web through a heated calender composed of two smooth steel rollers or passing heated steam, air or other gas through the web to cause the filaments to become softened and fuse to one another. As a result, the fabric is bonded throughout its area where the filaments intersect one another. Point bonding consists of using a heated calender nip to produce numerous separate and discrete point bond sites. The point bonding calender nip is comprised of two nip rolls, wherein at least one of the rolls has a surface with a pattern of protrusions. Typically, one of the heated rolls is a patterned roll and the cooperating roll has a smooth surface. As the web moves through the calender roll, the individual filaments are thermally bonded together at discrete locations or point bond sites where the filaments contact the protrusions of the patterned roll. Preferably, the calender rolls are engraved with a pattern that produces point bonds over about 10 to 40 percent of the area of web surface, and more preferably about 20 to 30 percent.

For the present invention, area bonding either with heated calender rolls or by passing a heated stream of fluid through the web is the preferred bonding process because it coheres the filaments together at points of intersection to produce a fabric that is quite strong and abrasion resistant. Area bonding imparts considerable strength to the fabric while retaining the integrity of the fibrous structure on both surfaces. Point bonding is also a very useful method of bonding the web because it bonds the filaments together in small, discrete, and closely spaced areas of the web to produce a fabric that is also quite strong and abrasion resistant.

Spunbonded nonwoven fabrics can be prepared from a variety of different thermoplastic polymers that are capable of being melt spun to form filaments. Examples of polymers that can be used to form the spunbonded nonwoven fabric include, without limitation, polyester, polyamide, polyolefins such as polypropylene, polyethylene, and olefin copolymers, or other thermoplastic polymers, copolymers and blends. These polymers may also be used in any combination or shape to form single component or multi-component (e.g. bicomponent filaments).

A particularly useful spunbond nonwoven fabric is comprised of polyester filaments, and more particularly is formed from polyester homopolymer filaments. A variety of additives can be used with the homopolymer including, but not limited to, optical brighteners, delusterants, opacifiers, colorants, antistats, and other common melt additives. A fibrous binder may also be included within the spunbond nonwoven fabric during the manufacturing process as continuous binder filaments in an amount effective to induce an adequate level of bonding. The binder is typically present in an amount ranging from about 2 to 20 weight percent, such as an amount of about 10 weight percent. The binder filaments are generally formed from a polymer composition exhibiting a melting or softening temperature at least about 10° C. lower than the homopolymer continuous filaments. Exemplary binder filaments may be formed from one or more lower melting polymers or copolymers, such as polyester copolymers. In one advantageous embodiment of the invention, the spunbond layer is produced by extruding polyester homopolymer matrix filaments (polyethylene terephthalate) interspersed with binder filaments formed from a lower melting polyester copolymer, such as polyethylene isophthalate. Typically, the homopolymer filaments constitute the matrix fiber and the copolymer filaments have a lower melting point and constitute a binder filament. Generally, as the web passes through the heated calender rolls or a stream of heated fluid, the filaments are bonded together at points of intersection. The portions of the binder filaments that are heated are melted or rendered tacky while in contact with the heat calender roll or stream of heated fluid, and as a result, the binder and matrix fibers are bonded to together to form a strong coherent fabric. In other embodiments, the spunbond fabric can be produced entirely from a single polymer composition, such as PET, and may be bonded by thermal point bonds. Alternatively, the spunbond layer may be formed of bicomponent filaments that include a higher melting point polymer component for strength and a lower melting point polymer component that will facilitate bonding of the filaments.

Suitable spunbond nonwoven fabrics should have a grab tensile strength in the machine direction and in the cross-machine direction of at least 5 lbs. The spunbonded nonwoven fabrics should also typically have a basis weight of from about 15 to 35 grams per square meter (gsm), and more desirably from about 20 to 25 gsm. The fabric typically has a machine direction elongation from about 20 to 50 percent, and somewhat more typically about 30 percent. The fabric typically has a Frasier porosity of at least 500 cubic feet of air per minute per square foot of fabric at a pressure differential of 0.5 inches of water.

Exterior layers 24 of a nonwoven web are positioned on opposite sides of the interior layer. The nonwoven exterior layers 24 are formed from cellulosic fibers that include a flame retardant chemical. The cellulosic fibers can be natural fibers such as cotton, flax, jute, hemp, ramie, wood pulp, or other natural cellulosics, or can be synthetic cellulosic fibers such as rayon, cellulose acetate, triacetate, or lyocell. The cellulosic fibers may be suitably blended with other natural or synthetic fibers. In one preferred embodiment the blend comprises at least 50% by weight flame retardant chemical infused rayon fibers and the balance polyester fibers. The exterior layers 24 can be produced by any of a variety of processes that are well-known in the nonwovens industry. In the preferred embodiment shown, the exterior layers are carded nonwoven webs formed of staple length fibers. More particularly, each exterior layer 24 can be formed either of a single card web or of two or more card webs, with each web comprising a blend of flame retardant chemical infused rayon fibers and polyester fibers.

Flame retardant chemicals that can be used in the present invention include various well-known inorganic and organic flame retardant additives based upon phosphorous, boron, antimony, and/or zirconium. Metal hydrates, such as aluminum hydroxide and magnesium hydroxide, and metal oxides, such as zinc oxide, are also useful in flame retardant systems. Examples of known inorganic flame retardants include phosphates such as diammonium phosphate, ammonium polyphosphates, ammonium dihydrogen phosphate, antimony compounds such as antimony trioxide and sodium antimonite, boron compounds such as boric acid, salts of boric acid, and zinc borate. Examples of known organic flame retardants include various organo-phosphorus compounds such as phosphonium chloride, trialkyl phosphates and phosphonates, aryl phosphonates. Phosphorous containing metal salts from aluminum, such as the aluminum salt of ethylmethylphosphinic acid, zinc, and calcium are also useful in flame retardant systems. Examples of commercially available flame retardant chemicals for use with cellulosic fibers include various products from Spartan Flame Retardants, Inc. such as Spartan AR 355, Spartan AR 295, Spartan X-12, Spartan FF4-72, Spartan FR-53 and Spartan 590D, Guardex, Glotard, and flame retardant FFR2 from Glo-Tex of Spartanburg S.C.

The flame retardant chemical can be sprayed, coated, padded or impregnated onto the fibers before or after fabric formation. For convenience and for economical application, it is most convenient to infuse the rayon or other cellulosic fiber with the flame retardant chemical prior to fabric formation. Suitable application techniques include spraying or dipping the fibers in the chemical, or using a pressure system (similar to what is used for beam dying in the textile industry) to force the flame retardant treatment into the fibers, followed typically by, but not limited to, through-air drying where the wet fibers are placed on a moving belt and carried through a heated oven to drive of the carrier liquid, typically water but other solvents may be utilized.

Preferably, the flame retardant chemical is applied to the cellulosic fiber in an amount ranging from 5% to 100% solids by weight, based on the weight of the fiber, and more desirably at a flame retardant concentration of from about 10 to 50% by weight. In the overall composite fabric, the flame retardant concentration is desirably from about 6% to about 25% by weight, based on the weight of the composite fabric.

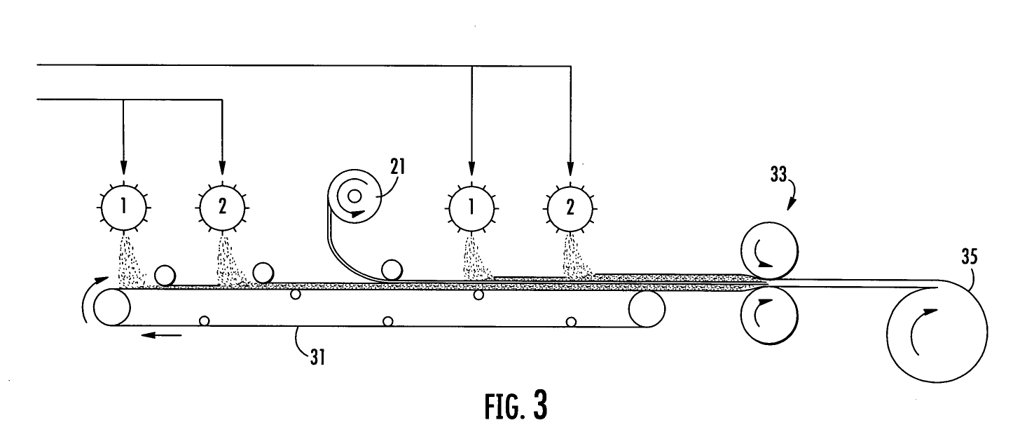

In FIG. 3, a suitable process line is shown for manufacturing the composite flame retardant fabric. The flame retardant-infused cellulosic fibers are optionally blended with thermoplastic fibers, such as polyester fibers and the fibers are fed to respective first and second textile carding machines (cards) 1, 2. In the cards, the fibers are formed into respective carded webs of fibers. The two carded webs are deposited one on top of the other on an advancing endless belt 31. A previously manufactured spunbond nonwoven web 21 is unwound from an unwind stand and is directed onto the previously deposited card webs. Then, a second pair of cards 3, 4 deposits respective third and fourth carded webs on top of the spunbond web 21. Press rolls P are used to compact the structure so that it can be transferred from the belt 31 and advanced through a heated nip defined by a cooperating pair of calender rolls 33. The heat and pressure applied by the calender nip softens the thermoplastic fibers in the carded webs so that they can fuse and bond to the interior spunbonded nonwoven web, resulting in an integrated unitary composite product. The resulting composite fabric is then wound up on a windup stand 35.

An illustrative, non-limiting example of a fabric construction is as follows: A three layer composite fabric is produced including outer carded layers (40 gsm) containing 30% by weight polyester bicomponent staple fibers and 70% by weight flame retardant treated cellulosic fibers. The carded layers are disposed on opposite sides of a central spunbond nonwoven fabric layer (20 gsm) formed of 100% polyethylene terephthalate (PET) filaments that have been thermally point bonded by passing through a patterned calender nip. The composite fabric is bonded by passing through a heated calender nip. The composite fabric has a total basis weight of 100 gsm and comprises approximately 12% flame retardant chemical by weight, 44% cellulosic fiber, 24% bicomponent binder fiber, and 20% spunbond PET.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composite flame retardant fabric comprising:
an interior layer formed of thermoplastic fibers, and
exterior nonwoven webs on opposite sides of the interior layer, the exterior webs being formed of cellulosic fibers that include a flame retardant chemical.

2. The flame retardant fabric of claim 1, wherein the interior layer is a spunbond nonwoven fabric.

3. The flame retardant fabric of claim 2, wherein the interior layer is a polyester spunbond nonwoven fabric.

4. The flame retardant fabric of claim 1, wherein the exterior layers are carded nonwoven webs comprising rayon fibers.

5. The flame retardant fabric of claim 4, wherein the flame retardant chemical is a non-halogenated flame retardant chemical.

6. The flame retardant fabric of claim 5, wherein the flame retardant chemical is selected from the group consisting of phosphates, sulfamates, and borates.

7. The flame retardant fabric of claim 4, wherein the carded nonwoven webs comprise a blend of rayon fibers and polyester fibers.

8. The flame retardant fabric of claim 7, wherein the blend comprises at least 50% by weight flame retardant-infused rayon fibers.

9. The flame retardant fabric of claim 8, wherein the flame retardant-infused rayon fibers include from 10 to 40% by weight flame retardant.

10. The flame retardant fabric of claim 1, wherein the fabric has a basis weight of from 2 to 6 ounces per square yard.

11. The flame retardant fabric of claim 1, wherein the flame retardant chemical is present at a concentration of 6 to 25% by weight of the composite flame retardant fabric.

12. A composite flame retardant fabric comprising:
an interior layer formed of a polyester spunbond nonwoven fabric, and
exterior layers on opposite sides of the interior layer, the exterior layers comprising carded nonwoven webs of a blend of rayon fibers and polyester fibers, at least the rayon fibers being impregnated with a flame retardant chemical, and
the exterior layers being bonded to the interior layer.

13. The flame retardant fabric of claim 12, wherein the blend comprises at least 50% by weight flame retardant-infused rayon fibers.

14. The flame retardant fabric of claim 13, wherein the flame retardant-infused rayon fibers include from 10 to 40% by weight flame retardant.

15. Flame retardant bedding comprising a decorative outer fabric, an inner cushioning member and a composite flame retardant fabric according to claim 1 positioned between the decorative outer fabric and the inner cushioning member.

16. The flame retardant bedding of claim 15, wherein the bedding comprises a mattress, box spring, or bed cover.

17. Flame retardant bedding comprising a decorative outer fabric, an inner cushioning member and a composite flame retardant fabric according to claim 12 positioned between the decorative outer fabric and the inner cushioning member.

18. Flame retardant furniture comprising a decorative outer fabric, an inner cushioning member and a composite flame retardant fabric according to claim 1 positioned between the decorative outer fabric and the inner cushioning member.

19. Flame retardant furniture comprising a decorative outer fabric, an inner cushioning member and a composite flame retardant fabric according to claim 12 positioned between the decorative outer fabric and the inner cushioning member.
